(19) United States
(12) Patent Application Publication
(10) Pub. No.: US 2024/0177155 A1
(43) Pub. Date: May 30, 2024

(54) DECENTRALIZED INFORMATION TRANSMISSION SYSTEM AND METHOD THEREOF

(71) Applicant: CHELPIS CO., LTD., Taipei (TW)

(72) Inventor: Bo-Wei Chen, Taipei (TW)

(21) Appl. No.: 17/993,883

(22) Filed: Nov. 24, 2022

(51) Int. Cl. G06Q 20/40; H04L 9/00; H04L 9/30

(52) U.S. Cl. CPC G06Q 20/401; H04L 9/30; H04L 9/50; G06Q 2220/00

(57) ABSTRACT

A decentralized information transmission system comprising: an information generating end, first and second blockchain networks, and an information receiving end, an information data transmitted by the generating end is encrypted by a public key into an encrypted file, a hash value is generated by a hash value generating module, the first blockchain network receives the hash value and the encrypted file, the second blockchain network receives the hash value and a receiving end address, the receiving end generates a data reading request for the second blockchain network, the second blockchain network transmits the hash value to the receiving end, the receiving end generates a data demanding request for the first blockchain network, the first blockchain network transmits the encrypted file to the receiving end, and the receiving end decrypts the encrypted file with a private key to obtain the information data transmitted by the generating end.

### BACKGROUND OF THE INVENTION

### Field of Invention

The invention relates to a decentralized information transmission system and a method thereof capable of avoiding information leakage and clearly verifying a result of information transmission through blockchain technology.

### Related Art

Web3 (or Web3.0), the “third-generation Internet” in Chinese, refers to a network system composed of blockchains, the core of which is decentralization, that is, information transmission between users is no longer relied on platforms established by the government and large technology companies to upload and share content, but users build and operate various parts of the network themselves. Therefore, with the development of the Internet and digital information, information transmission between people currently mainly uses the third-generation Internet to transmit information, but some third-generation Internet websites mainly use wallets for authentication, there is no reliable channel for transmitting information to the wallet, and can only be bound to using email. Therefore, there is a risk of being peeped in the transmission of information between users, after the sender sends the information, the sender of the information cannot determine whether the information has been delivered to the designated recipient, nor can it be known if the recipient has received the information the sender has sent.

Therefore, the inventor of the invention and relevant manufacturers engaged in this industry are eager to research and make improvement to solve the above-mentioned problems and drawbacks in the prior art.

### SUMMARY OF THE INVENTION

Therefore, in order to effectively solve the above problems, a main object of the invention is to provide a decentralized information transmission system and a method thereof capable of avoiding information leakage and clearly verifying a result of information transmission through blockchain technology.

In order to achieve the above object, the invention provides a decentralized information transmission system comprising: an information generating end, the information generating end has a hash value generating module and a receiving end public key, an information data to be transmitted by the information generating end is encrypted by the receiving end public key into an encrypted file, and the information generating end generates a hash value corresponding to the encrypted file by the hash value generating module; a first blockchain network, the first blockchain network is signally connected to the information generating end, and the encrypted file hash value and the encrypted file generated by the information generating end are transmitted to the first blockchain network and stored by the first blockchain network; a second blockchain network, the second blockchain network is signally connected to the information generating end, the information generating end generates a receiving end address by the receiving end public key, and the encrypted file hash value and the corresponding receiving end address generated by the information generating end are transmitted to the second blockchain network; and an information receiving end, the information receiving end is signally connected to the first blockchain network and the second blockchain network, the information receiving end generates a data reading request for the second blockchain network with the receiving end address, the second blockchain network transmits the encrypted file hash value of the receiving end address to the information receiving end according to the data reading request, the information receiving end generates a data demanding request for the first blockchain network according to the encrypted file hash value, the first blockchain network transmits the encrypted file of the encrypted file hash value to the information receiving end according to the data demanding request, and the information receiving end decrypts the encrypted file with a receiving end private key to obtain the information data to be transmitted by the information generating end.

According to one embodiment of the decentralized information transmission system of the invention, wherein the information generating end obtains the receiving end public key from the second blockchain network.

According to one embodiment of the decentralized information transmission system of the invention, wherein the first blockchain network has a plurality of data storage blocks, and the encrypted file hash value and the encrypted file generated by the information generating end are stored in the same data storage block.

According to one embodiment of the decentralized information transmission system of the invention, wherein the information receiving end has the receiving end public key and generates the receiving end address by the receiving end public key, and the information receiving end uses the receiving end address to generate the data reading request for the second blockchain network.

According to one embodiment of the decentralized information transmission system of the invention, wherein the information generating end generates a first file hash value for the information data by the hash value generating module, the information generating end generates a second file hash value for the first file hash value by the hash value generating module and transmits the second file hash value to the second blockchain network, the information receiving end uses the hash value generation module to generate a to-be-verified hash value for the information data and transmits the to-be-verified hash value to the second blockchain network, the second blockchain network uses a verification smart contract to compare and verify the second file hash value with the to-be-verified hash value, the verification smart contract generates a verification hash value for the to-be-verified hash value by the hash value generating module, and the verification smart contract compares the second file hash value with the verification hash value and generates a verification information, so that the information generating end is capable of acquiring from the verification information whether the information receiving end has received the information data.

According to one embodiment of the decentralized information transmission system of the invention, wherein the second blockchain network further comprises a payment smart contract, after comparing and verifying with the payment smart contract in the second blockchain network and generating the verification information, the information generating end pays a virtual currency according to the payment smart contract.

The invention further provides a decentralized information transmission method comprising:
a receiving end public key encrypting an information data to be transmitted by an information generating end into an encrypted file, a hash value generating module generating a hash value corresponding to the encrypted file;
transmitting the encrypted file hash value and the encrypted file generated by the information generating end to the first blockchain network;
the information generating end transmitting the encrypted file hash value and a corresponding generated receiving end address to a second blockchain network;
an information receiving end generating a data reading request for the second blockchain network with the receiving end address;
the second blockchain network transmitting the encrypted file hash value of the receiving end address to the information receiving end according to the data reading request;
the information receiving end generating a data demanding request for the first blockchain network according to the encrypted file hash value;
the first blockchain network transmitting the encrypted file of the encrypted file hash value to the information receiving end according to the data demanding request; and
the information receiving end decrypting the encrypted file with a receiving end private key to obtain the information data to be transmitted by the information generating end.

According to one embodiment of the decentralized information transmission method of the invention, wherein the information generating end generates the receiving end address by the receiving end public key.

According to one embodiment of the decentralized information transmission method of the invention, wherein the information receiving end has the receiving end public key and generates the receiving end address by the receiving end public key, and the information receiving end uses the receiving end address to generate the data reading request for the second blockchain network.

According to one embodiment of the decentralized information transmission method of the invention, wherein the information generating end obtains the receiving end public key from the second blockchain network.

According to one embodiment of the decentralized information transmission method of the invention, wherein the first blockchain network has a plurality of data storage blocks, and the encrypted file hash value and the encrypted file generated by the information generating end are stored in the same data storage block.

According to one embodiment of the decentralized information transmission method of the invention, further comprising:
the information generating end generating a first file hash value for the information data by the hash value generating module, the hash value generating module generating a second file hash value for the first file hash value and transmitting the second file hash value to the second blockchain network;
the information receiving end using the hash value generation module to generate a to-be-verified hash value for the information data and transmitting the to-be-verified hash value to the second blockchain network;
the second blockchain network generating a verification hash value for the to-be-verified hash value by the hash value generating module;
the second blockchain network comparing the second file hash value with the verification hash value and generating a verification information; and
the information generating end acquiring from the verification information whether the information receiving end receiving the transmitted information data.

According to one embodiment of the decentralized information transmission method of the invention, wherein the second blockchain network further comprises a payment smart contract, after comparing and verifying with the payment smart contract in the second blockchain network and generating the verification information, the information generating end pays a virtual currency according to the payment smart contract.

### BRIEF DESCRIPTION OF THE DRAWINGS

FIG. 1 is a system architectural diagram of a decentralized information transmission system of the invention.

FIG. 2 is a schematic diagram of implementation of information transmission of the decentralized information transmission system of the invention.

FIG. 3 is a schematic diagram of implementation of information confirmation of the decentralized information transmission system of the invention.

FIG. 4 is a flow chart of a decentralized information transmission method of the invention.

FIG. 5 is a flow chart of information confirmation of the decentralized information transmission method of the invention.

### DETAILED DESCRIPTION OF THE INVENTION

The above objects of the invention, as well as its structural and functional features, will be described in accordance with the preferred embodiments of the accompanying drawings.

In the following, for the formation and technical content related to a decentralized information transmission system and a method thereof of the invention, various applicable examples are exemplified and explained in detail with reference to the accompanying drawings; however, the invention is of course not limited to the enumerated embodiments, drawings, or detailed descriptions.

Furthermore, those who are familiar with this technology should also understand that the enumerated embodiments and accompanying drawings are only for reference and explanation, and are not used to limit the invention; other modifications or alterations that can be easily implemented based on the detailed descriptions of the invention are also deemed to be within the scope without departing from the spirit or intention thereof as defined by the appended claims and their legal equivalents.

And, the directional terms mentioned in the following embodiments, for example: “above”, “below”, “left”, “right”, “front”, “rear”, etc., are only directions referring in the accompanying drawings. Therefore, the directional terms are used to illustrate rather than limit the invention. In addition, in the following embodiments, the same or similar elements will be labeled with the same or similar numerals.

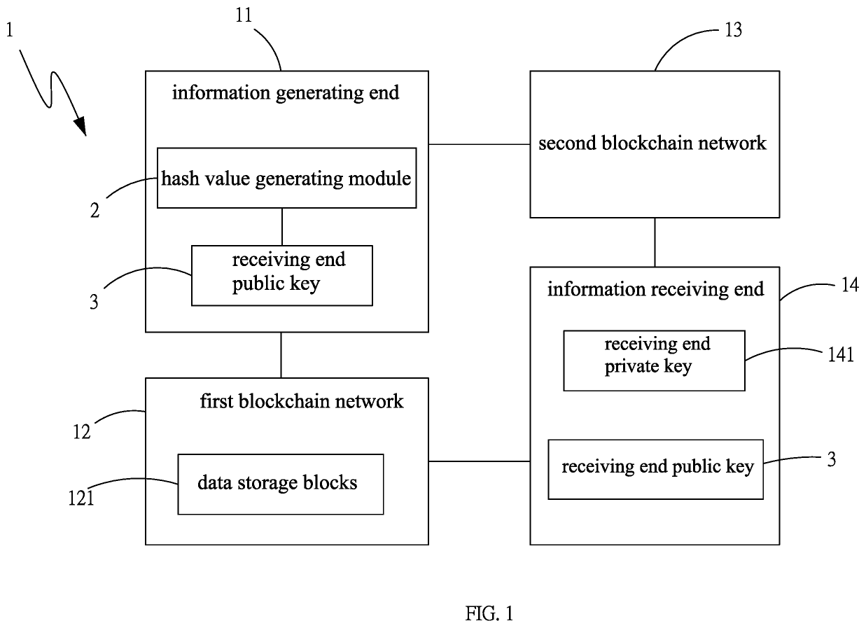

Please refer to FIG. 1 for a system architectural diagram of a decentralized information transmission system of the invention, wherein a decentralized information transmission system 1 comprises at least one information generating end 11, at least one first blockchain network 12, at least one second blockchain network 13, and at least one information receiving end 14, wherein the information generating end 11 and the information receiving end 14 can be electronic devices, mobile phones, computers or tablet computers, etc.

Wherein the information generating end 11 has a hash value generating module 2, wherein the hash value generating module 2 is a hash value generator, the information generating end 11 can obtain the hash value generating module 2 through installation of an application program or a webpage or an interface where the hash value generator can be obtained, the information generating end 11 has a receiving end public key 3, the receiving end public key 3 is publicly provided by the information receiving end 14, the information generating end 11 has various ways to obtain the receiving end public key 3, for example, the information receiving end 14 provides the receiving end public key 3 to the second blockchain network 13, and the information generating end 11 directly obtains the receiving end public key 3 from the second blockchain network 13; alternatively, the information receiving end 14 uses a private key to sign in the second blockchain network 13 to generate a receiving end information, the receiving end information includes the receiving end public key 3, and the information generating end 11 directly acquires the receiving end information from the second blockchain network 13 in order to obtain the receiving end public key 3 from the receiving end information; alternatively, the information receiving end 14 provides the receiving end information or the receiving end public key 3 on a transaction webpage or a public webpage with a virtual currency, and the information generating end 11 directly obtains the receiving end public key 3 from the transaction webpage or the public webpage; alternatively, a public key collation platform assists in collecting public keys of the information receiving ends 14, the public key collation platform can find transaction information in data blocks in a blockchain, and then find the receiving end public key 3 from the transaction information, the public key collation platform can put the receiving end public key 3 in a network or the second blockchain network 13 or other blockchain networks, and the information generating end 11 directly obtains the receiving end public key 3 from the network or the second blockchain network 13 or the other blockchain networks; wherein a manner in which the information generating end 11 obtains the receiving end public key 3 is not limited thereto.

Wherein the first blockchain network 12 is signally connected to the information generating end 11, the first blockchain network 12 comprises a plurality of data storage blocks 121, and the first blockchain network 12 can be implemented by using, for example, a distributed file system (DFS) or an interplanetary file system (IPFS), but is not limited thereto.

Wherein the second blockchain network 13 is signally connected to the information generating end 11.

Wherein the information receiving end 14 is signally connected to the first blockchain network 12 and the second blockchain network 13, and the information receiving end 14 has a receiving end private key 141 and the receiving end public key 3.

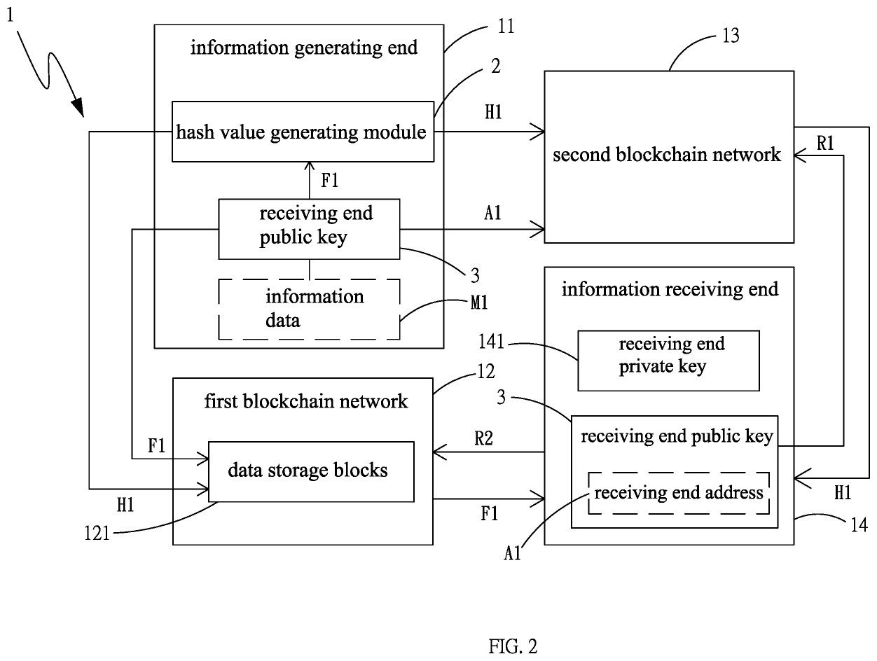

Please refer to FIG. 2 for a schematic diagram of implementation of information transmission of the decentralized information transmission system of the invention, wherein the information generating end 11 generates an information data M1 to be transmitted to the information receiving end 14, the information generating end 11 first encrypts the to-be-transmitted information data M1 by the receiving end public key 3 into an encrypted file F1, and the information generating end 11 generates an encrypted file hash value H1 corresponding to the encrypted file F1 by the hash value generating module 2 at the same time. The information generating end 11 has the encrypted file F1 and the encrypted file hash value H1, the information generating end 11 transmits the encrypted file hash value H1 and the encrypted file F1 to the first blockchain network 12, and the encrypted file hash value H1 and the encrypted file F1 received by the first blockchain network 12 are stored in the same data storage block 121, wherein the information data M1 can be an electronic file, a text information, a graphic information, etc.

In addition, the information generating end 11 generates a receiving end address A1 by the receiving end public key 3, when the information generating end 11 has the receiving end address A1, the information generating end 11 transmits the corresponding encrypted file hash value H1 and the receiving end address A1 to the second blockchain network 13.

The information receiving end 14 has the receiving end public key 3 and generates the receiving end address A1 by the receiving end public key 3, the information receiving end 14 can use the receiving end address A1 to regularly or irregularly generate a data reading request R1 for the second blockchain network 13, when the second blockchain network 13 receives the data reading request R1 of the receiving end address A1, the second blockchain network 13 searches whether there is the corresponding encrypted file hash value H1 according to the receiving end address A1. If the receiving end address A1 has the corresponding encrypted file hash value H1, the second blockchain network 13 then transmits the encrypted file hash value H1 to the information receiving end 14 that generates the receiving end address A1. If the receiving end address A1 does not have the corresponding encrypted file hash value H1, the information receiving end 14 does not receive the encrypted file hash value H1.

The information receiving end 14 receives the encrypted file hash value H1, the information receiving end 14 generates a data demanding request R2 for the first blockchain network 12 according to the encrypted file hash value H1, when the first blockchain network 12 receives the data demanding request R2, the first blockchain network 12 finds the encrypted file F1 in the data storage blocks 121 that matches the encrypted file hash value H1. The first blockchain network 12 transmits the encrypted file F1 matching the encrypted file hash value H1 to the information receiving end 14, after the information receiving end 14 receives the encrypted file F1, the information receiving end 14 uses the receiving end private key 141 to decrypt the encrypted file F1 to obtain the information data M1 to be transmitted by the information generating end 11. Thereby the information generating end 11 is capable of transmitting the information data M1 to the information receiving end 14 via the first blockchain network 12 and the second blockchain network 13, and transmission of the information data M1 can be achieved through blockchain technology to achieve an efficacy of avoiding information leakage.

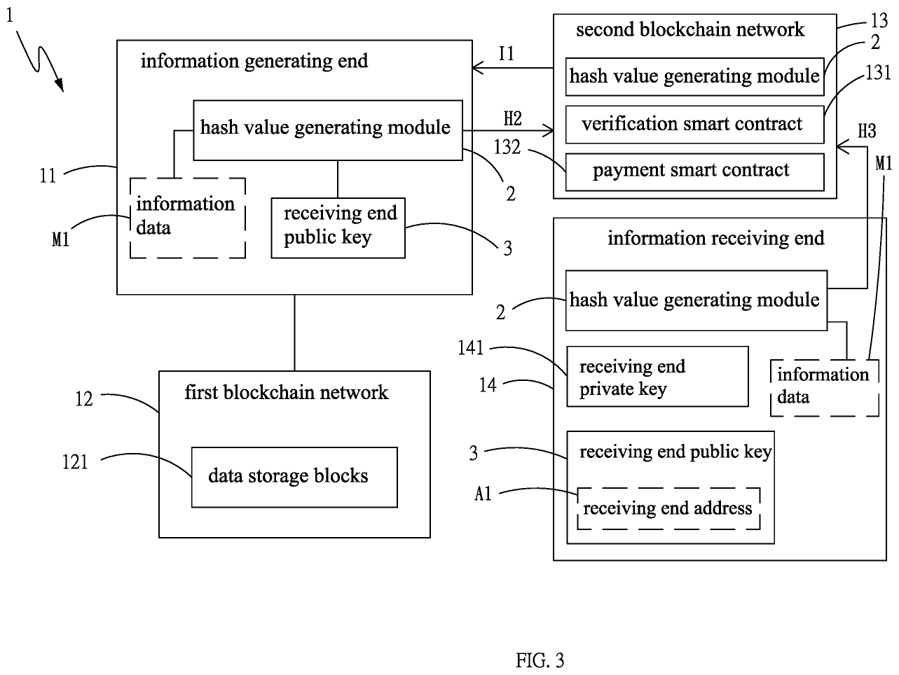

In addition, please refer to FIG. 3 for a schematic diagram of implementation of information confirmation of the decentralized information transmission system of the invention, wherein after the information generating end 11 transmits the information data M1 to the information receiving end 14 via the first blockchain network 12 and the second blockchain network 13, the information generating end 11 is also capable of confirming whether the information data M1 has been received and read by the information receiving end 14 through the decentralized information transmission system 1.

Wherein the information data M1 generates a first file hash value for the information data M1 by the hash value generating module 2, when the information generating end 11 has the first file hash value, the information generating end 11 generates a second file hash value H2 for the first file hash value by the hash value generating module 2, when the information generating end 11 has the second file hash value H2, the information generating end 11 transmits the second file hash value H2 to the second blockchain network 13.

The information receiving end 14 also uses the hash value generating module 2 to generate a to-be-verified hash value H3 for the received information data M1, and the information receiving end 14 transmits the to-be-verified hash value H3 to the second blockchain network 13, when the second blockchain network 13 has the second file hash value H2 and the to-be-verified hash value H3, the second blockchain network 13 uses a verification smart contract 131 to compare and verify the second file hash value H2 with the to-be-verified hash value H3, the verification smart contract 131 uses the hash value generating module 2 to generate a verification hash value H4 for the to-be-verified hash value H3, and at the same time the verification smart contract 131 compares the second file hash value H2 with the verification hash value H4. The verification smart contract 131 generates a verification information I1 after comparison is completed, and the verification information I1 can be displayed in two ways, one display method is to display the verification information I1 in a verification field. Wherein if the verification smart contract 131 compares the second file hash value H2 and the verification hash value H4 to be a same hash value, the verification field displays the read verification information I1; on the contrary, when the verification smart contract 131 does not have the second file hash value H2 compared with the verification hash value H4, or the second file hash value H2 and the verification hash value H4 are compared to be different hash values, then the verification field displays the unread verification Information I1. Another display method is that the verification smart contract 131 directly generates the read verification information I1, thereby when the information generating end 11 performs transmission of information or confirmation of information in the second blockchain network 13 again, the information generating end 11 is capable of acquiring through the verification information I1 whether the information receiving end 14 has received the information data M1, so as to achieve an efficacy of clearly verifying a result of information transmission.

In addition, the second blockchain network 13 further comprises a payment smart contract 132, after the verification smart contract 131 of the second blockchain network 13 is compared and the verification information I1 is generated, the information generating end 11 pays a virtual currency to the information receiving end 14 according to the payment smart contract 131 to encourage the information receiving end 14 to receive the information data M1, or the information generating end 11 provides a virtual currency to an owner of the payment smart contract 132 or a platform that generates the payment smart contract 132 to enable the three parties including the information generating end 11 and the information receiving end 14 to complete procedures of information transmission and user payment based on the payment smart contract 132.

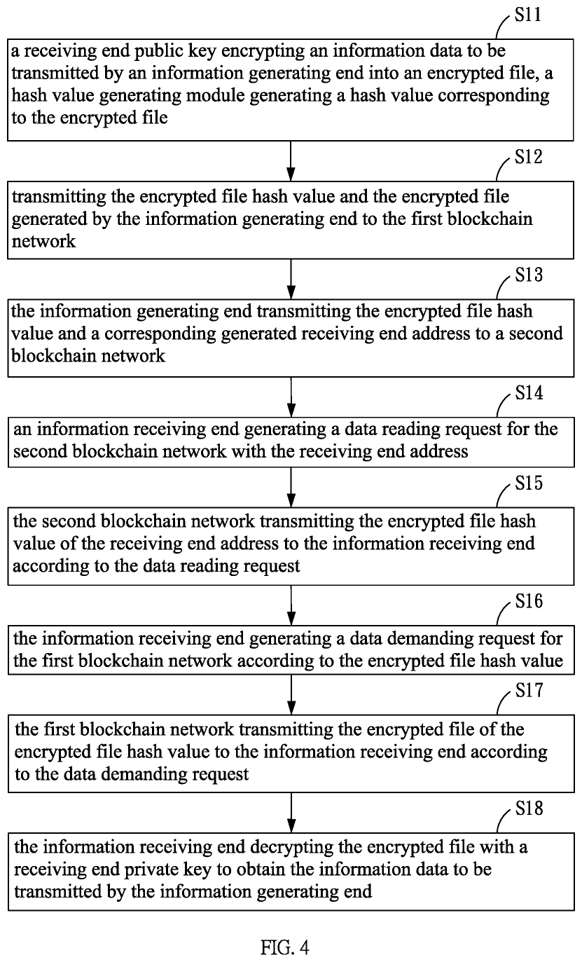

In order to clearly illustrate an operation process of this embodiment, please refer to FIG. 4 for a flow chart of a decentralized information transmission method of the invention. The decentralized information transmission method comprises following steps:
step S11: a receiving end public key encrypting an information data to be transmitted by an information generating end into an encrypted file, a hash value generating module generating a hash value corresponding to the encrypted file; wherein the information generating end 11 generates an information data M1 to be transmitted to the information receiving end 14, the information generating end 11 first encrypts the to-be-transmitted information data M1 by the receiving end public key 3 into an encrypted file F1, and the information generating end 11 generates an encrypted file hash value H1 corresponding to the encrypted file F1 by the hash value generating module 2 at the same time, the information generating end 11 can be an electronic device, a mobile phone, a computer or a tablet computer, etc., and the information data M1 can be an electronic file, a text information, a graphic information, etc.;
step S12: transmitting the encrypted file hash value and the encrypted file generated by the information generating end to the first blockchain network; wherein the information generating end 11 has the encrypted file F1 and the encrypted file hash value H1, the information generating end 11 transmits the encrypted file hash value H1 and the encrypted file F1 to the first blockchain network 12, and the encrypted file hash value H1 and the encrypted file F1 received by the first blockchain network 12 are stored in the same data storage block 121, wherein the first blockchain network 12 can be implemented by using, for example, a distributed file system (DFS) or an interplanetary file system (IPFS), but is not limited thereto;
step S13: the information generating end transmitting the encrypted file hash value and a corresponding generated receiving end address to a second blockchain network; wherein the information generating end 11 generates a receiving end address A1 by the receiving end public key 3, when the information generating end 11 has the receiving end address A1, the information generating end 11 transmits the corresponding encrypted file hash value H1 and the receiving end address A1 to the second blockchain network 13;
step S14: an information receiving end generating a data reading request for the second blockchain network with the receiving end address; wherein the information receiving end 14 has the receiving end public key 3 and generates the receiving end address A1 by the receiving end public key 3, the information receiving end 14 can use the receiving end address A1 to regularly or irregularly generate a data reading request R1 for the second blockchain network 13, the information receiving end 14 can be an electronic device, a mobile phone, a computer or a tablet computer, etc.;
step S15: the second blockchain network transmitting the encrypted file hash value of the receiving end address to the information receiving end according to the data reading request; wherein when the second blockchain network 13 receives the data reading request R1 of the receiving end address A1, the second blockchain network 13 searches whether there is the corresponding encrypted file hash value H1 according to the receiving end address A1, if the receiving end address A1 has the corresponding encrypted file hash value H1, the second blockchain network 13 then transmits the encrypted file hash value H1 to the information receiving end 14 that generates the receiving end address A1, if the receiving end address A1 does not have the corresponding encrypted file hash value H1, the information receiving end 14 does not receive the encrypted file hash value H1;
step S16: the information receiving end generating a data demanding request for the first blockchain network according to the encrypted file hash value; wherein the information receiving end 14 receives the encrypted file hash value H1, the information receiving end 14 generates a data demanding request R2 for the first blockchain network 12 according to the encrypted file hash value H1;
step S17: the first blockchain network transmitting the encrypted file of the encrypted file hash value to the information receiving end according to the data demanding request; wherein when the first blockchain network 12 receives the data demanding request R2, the first blockchain network 12 finds the encrypted file F1 in the data storage blocks 121 that matches the encrypted file hash value H1, the first blockchain network 12 transmits the encrypted file F1 matching the encrypted file hash value H1 to the information receiving end 14; and
step S18: the information receiving end decrypting the encrypted file with a receiving end private key to obtain the information data to be transmitted by the information generating end; wherein after the information receiving end 14 receives the encrypted file F1, the information receiving end 14 uses the receiving end private key 141 to decrypt the encrypted file F1 to obtain the information data M1 to be transmitted by the information generating end 11, thereby the information generating end 11 is capable of transmitting the information data M1 to the information receiving end 14 via the first blockchain network 12 and the second blockchain network 13, and transmission of the information data M1 can be achieved through blockchain technology to achieve an efficacy of avoiding information leakage.

Wherein the hash value generating module 2 is a hash value generator, the information generating end 11 can obtain the hash value generating module 2 through installation of an application program or a webpage or an interface where the hash value generator can be obtained, the receiving end public key 3 is publicly provided by the information receiving end 14, the information generating end 11 has various ways to obtain the receiving end public key 3, for example, the information receiving end 14 provides the receiving end public key 3 to the second blockchain network 13, and the information generating end 11 directly obtains the receiving end public key 3 from the second blockchain network 13; alternatively, the information receiving end 14 uses a private key to sign in the second blockchain network 13 to generate a receiving end information, the receiving end information includes the receiving end public key 3, and the information generating end 11 directly acquires the receiving end information from the second blockchain network 13 in order to obtain the receiving end public key 3 from the receiving end information; alternatively, the information receiving end 14 provides the receiving end information or the receiving end public key 3 on a transaction webpage or a public webpage with a virtual currency, and the information generating end 11 directly obtains the receiving end public key 3 from the transaction webpage or the public webpage; alternatively, a public key collation platform assists in collecting public keys of the information receiving ends 14, the public key collation platform can find transaction information in data blocks in a blockchain, and then find the receiving end public key 3 from the transaction information, the public key collation platform can put the receiving end public key 3 in a network or the second blockchain network 13 or other blockchain networks, and the information generating end 11 directly obtains the receiving end public key 3 from the network or the second blockchain network 13 or the other blockchain networks; wherein a manner in which the information generating end 11 obtains the receiving end public key 3 is not limited thereto.

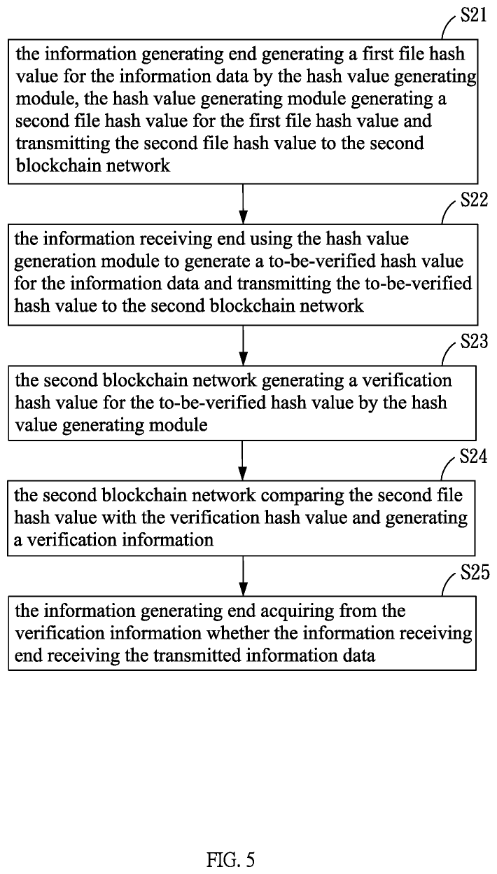

Please refer to FIG. 5 for a flow chart of information confirmation of the decentralized information transmission method of the invention, wherein after the information generating end 11 transmits the information data M1 to the information receiving end 14 via the first blockchain network 12 and the second blockchain network 13, the information generating end 11 is also capable of confirming whether the information data M1 has been received and read by the information receiving end 14 through the decentralized information transmission system 1, and an information confirmation process comprises following steps:
step S21: the information generating end generating a first file hash value for the information data by the hash value generating module, the hash value generating module generating a second file hash value for the first file hash value and transmitting the second file hash value to the second blockchain network; wherein the information data M1 generates a first file hash value for the information data M1 by the hash value generating module 2, when the information generating end 11 has the first file hash value, the information generating end 11 generates a second file hash value H2 for the first file hash value by the hash value generating module 2, when the information generating end 11 has the second file hash value H2, the information generating end 11 transmits the second file hash value H2 to the second blockchain network 13;
step S22: the information receiving end using the hash value generation module to generate a to-be-verified hash value for the information data and transmitting the to-be-verified hash value to the second blockchain network; wherein the information receiving end 14 also uses the hash value generating module 2 to generate a to-be-verified hash value H3 for the received information data M1, and the information receiving end 14 transmits the to-be-verified hash value H3 to the second blockchain network 13;
step S23: the second blockchain network generating a verification hash value for the to-be-verified hash value by the hash value generating module; wherein when the second blockchain network 13 has the second file hash value H2 and the to-be-verified hash value H3, the second blockchain network 13 uses a verification smart contract 131 to compare and verify the second file hash value H2 with the to-be-verified hash value H3, the verification smart contract 131 uses the hash value generating module 2 to generate a verification hash value H4 for the to-be-verified hash value H3;
step S24: the second blockchain network comparing the second file hash value with the verification hash value and generating a verification information; wherein the verification smart contract 131 compares the second file hash value H2 with the verification hash value H4, the verification smart contract 131 generates a verification information I1 after comparison is completed, and the verification information I1 can be displayed in two ways, one display method is to display the verification information I1 in a verification field, wherein if the verification smart contract 131 compares the second file hash value H2 and the verification hash value H4 to be a same hash value, the verification field displays the read verification information I1; on the contrary, when the verification smart contract 131 does not have the second file hash value H2 compared with the verification hash value H4, or the second file hash value H2 and the verification hash value H4 are compared to be different hash values, then the verification field displays the unread verification Information I1, another display method is that the verification smart contract 131 directly generates the read verification information I1; and
step S25: the information generating end acquiring from the verification information whether the information receiving end receiving the transmitted information data; wherein when the information generating end 11 performs transmission of information or confirmation of information in the second blockchain network 13 again, the information generating end 11 is capable of acquiring through the verification information I1 whether the information receiving end 14 has received the information data M1, so as to achieve an efficacy of clearly verifying a result of information transmission.

In addition, the second blockchain network 13 further comprises the payment smart contract 132, after the verification smart contract 131 of the second blockchain network 13 is compared and the verification information I1 is generated, the information generating end 11 pays a virtual currency to the information receiving end 14 according to the payment smart contract 131 to encourage the information receiving end 14 to receive the information data M1, or the information generating end 11 pays a virtual currency to an owner of the payment smart contract 132 or a platform that generates the payment smart contract 132 to enable the three parties including the information generating end 11 and the information receiving end 14 to complete procedures of information transmission and user payment based on the payment smart contract 132.

It is to be understood that the above description is only preferred embodiments of the invention and is not used to limit the invention, and changes in accordance with the concepts of the invention may be made without departing from the spirit of the invention, for example, the equivalent effects produced by various transformations, variations, modifications and applications made to the configurations or arrangements shall still fall within the scope covered by the appended claims of the invention.

What is claimed is:

1. A decentralized information transmission system comprising:
an information generating end, the information generating end having a hash value generating module and a receiving end public key, an information data to be transmitted by the information generating end being encrypted by the receiving end public key into an encrypted file, and the information generating end generating a hash value corresponding to the encrypted file by the hash value generating module;
a first blockchain network, the first blockchain network being signally connected to the information generating end, and the encrypted file hash value and the encrypted file generated by the information generating end being transmitted to the first blockchain network and stored by the first blockchain network;
a second blockchain network, the second blockchain network being signally connected to the information generating end, the information generating end generating a receiving end address by the receiving end public key, and the encrypted file hash value and the corresponding receiving end address generated by the information generating end being transmitted to the second blockchain network; and
an information receiving end, the information receiving end being signally connected to the first blockchain network and the second blockchain network, the information receiving end generating a data reading request for the second blockchain network with the receiving end address, the second blockchain network transmitting the encrypted file hash value of the receiving end address to the information receiving end according to the data reading request, the information receiving end generating a data demanding request for the first blockchain network according to the encrypted file hash value, the first blockchain network transmitting the encrypted file of the encrypted file hash value to the information receiving end according to the data demanding request, and the information receiving end decrypting the encrypted file with a receiving end private key to obtain the information data to be transmitted by the information generating end.

2. The decentralized information transmission system as claimed in claim 1, wherein the information generating end obtains the receiving end public key from the second blockchain network.

3. The decentralized information transmission system as claimed in claim 1, wherein the first blockchain network has a plurality of data storage blocks, and the encrypted file hash value and the encrypted file generated by the information generating end are stored in the same data storage block.

4. The decentralized information transmission system as claimed in claim 1, wherein the information receiving end has the receiving end public key and generates the receiving end address by the receiving end public key, and the information receiving end uses the receiving end address to generate the data reading request for the second blockchain network.

5. The decentralized information transmission system as claimed in claim 1, wherein the information generating end generates a first file hash value for the information data by the hash value generating module, the information generating end generates a second file hash value for the first file hash value by the hash value generating module and transmits the second file hash value to the second blockchain network, the information receiving end uses the hash value generation module to generate a to-be-verified hash value for the information data and transmits the to-be-verified hash value to the second blockchain network, the second blockchain network uses a verification smart contract to compare and verify the second file hash value with the to-be-verified hash value, the verification smart contract generates a verification hash value for the to-be-verified hash value by the hash value generating module, and the verification smart contract compares the second file hash value with the verification hash value and generates a verification information, so that the information generating end is capable of acquiring from the verification information whether the information receiving end has received the information data.

6. The decentralized information transmission system as claimed in claim 5, wherein the second blockchain network further comprises a payment smart contract, after comparing and verifying with the payment smart contract in the second blockchain network and generating the verification information, the information generating end pays a virtual currency according to the payment smart contract.

7. A decentralized information transmission method comprising:
a receiving end public key encrypting an information data to be transmitted by an information generating end into an encrypted file, a hash value generating module generating a hash value corresponding to the encrypted file;
transmitting the encrypted file hash value and the encrypted file generated by the information generating end to the first blockchain network;
the information generating end transmitting the encrypted file hash value and a corresponding generated receiving end address to a second blockchain network;
an information receiving end generating a data reading request for the second blockchain network with the receiving end address;
the second blockchain network transmitting the encrypted file hash value of the receiving end address to the information receiving end according to the data reading request;
the information receiving end generating a data demanding request for the first blockchain network according to the encrypted file hash value;
the first blockchain network transmitting the encrypted file of the encrypted file hash value to the information receiving end according to the data demanding request; and
the information receiving end decrypting the encrypted file with a receiving end private key to obtain the information data to be transmitted by the information generating end.

8. The decentralized information transmission method as claimed in claim 7, wherein the information generating end generates the receiving end address by the receiving end public key.

9. The decentralized information transmission method as claimed in claim 8, wherein the information receiving end has the receiving end public key and generates the receiving end address by the receiving end public key, and the information receiving end uses the receiving end address to generate the data reading request for the second blockchain network.

10. The decentralized information transmission method as claimed in claim 7, wherein the information generating end obtains the receiving end public key from the second blockchain network.

11. The decentralized information transmission method as claimed in claim 7, wherein the first blockchain network has a plurality of data storage blocks, and the encrypted file hash value and the encrypted file generated by the information generating end are stored in the same data storage block.

12. The decentralized information transmission method as claimed in claim 7, further comprising:
the information generating end generating a first file hash value for the information data by the hash value generating module, the hash value generating module generating a second file hash value for the first file hash value and transmitting the second file hash value to the second blockchain network;
the information receiving end using the hash value generation module to generate a to-be-verified hash value for the information data and transmitting the to-be-verified hash value to the second blockchain network;
the second blockchain network generating a verification hash value for the to-be-verified hash value by the hash value generating module;
the second blockchain network comparing the second file hash value with the verification hash value and generating a verification information; and
the information generating end acquiring from the verification information whether the information receiving end receiving the transmitted information data.

13. The decentralized information transmission method as claimed in claim 7, wherein the second blockchain network further comprises a payment smart contract, after comparing and verifying with the payment smart contract in the second blockchain network and generating the verification information, the information generating end pays a virtual currency according to the payment smart contract.
